(19) United States
(12) Patent Application Publication
(10) Pub. No.: US 2008/0175567 A1
(43) Pub. Date: Jul. 24, 2008

(54) Video recording and reproducing apparatus and data control method thereof

(75) Inventors: Mitsunobu WATANABE, Yokohama (JP); Satoshi IIMURO, Yokohama (JP); Yukihide INAGAKI, Fujisawa (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 12/005,752

(22) Filed: Dec. 27, 2007

(30) Foreign Application Priority Data
Jan. 16, 2007 (JP) 2007-007231

(51) Int. Cl. H04N 7/167; H04L 9/00; H04N 7/26

(52) U.S. Cl. 386/124; 380/277; 380/200

(57) ABSTRACT

In a video recording and reproducing apparatus, data is divided into a plurality of data blocks encrypted with corresponding encryption keys and is recorded in a recording medium such as a HDD. The recorded data is copied from a data source to a move destination in the recording medium. Then, the encryption keys are successively copied from the data source to the move destination in the recording medium and the encryption keys stored in the data source are deleted. Thereafter, the data blocks stored in the data source are simultaneously deleted. Accordingly, a risk that a recorded file being moved is divided due to an interruption may be reduced.

### CLAIMS OF PRIORITY

The present application claims priority from Japanese application serial no. JP2007-007321, filed on Jan. 16, 2007, the content of which is hereby incorporated by reference into this application.

### BACKGROUND OF THE INVENTION

The present invention relates to video recording and reproducing apparatuses and data control methods thereof. In particular, the present invention relates to a video recording and reproducing apparatus which is capable of recording a broadcast program as data in an information recording medium such as an incorporated HDD and a removable HDD and which is capable of moving and deleting the recorded data, and further capable of performing special reproduction of the recorded data. Furthermore, the present invention particularly relates to a data control method for the video recording and reproducing apparatus.

In recent years, in a field of the television broadcasting, analog broadcasting generally used has been replaced by digital broadcasting.

In the digital broadcasting, for example, an image compression technique in which image data as digital data is compressed and transmitted is used. This technique has an advantage in that deterioration of an image caused due to an improper reception environment can be suppressed. A brief of the digital broadcasting is disclosed in “Points Illustrated: Computer/Communication/Broadcasting Standard Dictionary,” Chapter 13 (pp. 628 to 689), edited by Mitsutoshi Hatori, ASCII Corporation, first edition, May 1998.

The MPEG (Moving Picture Experts Group) standard is used as a de facto standard of the image compression technique employing a digital method. In the MPEG standard, images are categorized into three picture types, i.e., an I (Intra) picture, a P (Predictive) picture, and a B (Bidirectionally predictive) picture. The I picture is a frame which keeps its independency in a GOP (Group of Pictures) and performs encoding processing without reference to any pieces of data representing other pictures. Each of the B picture and the P picture performs encoding processing with reference to a preceding and succeeding pictures. In special reproduction, such as double-speed reproduction, only I pictures are used to reproduce video images.

Image data is generally recorded as a file in an HDD in a file system and a user can move and delete the file. In most OSs, a tree structure is employed for the file system. A known tree structure includes nodes corresponding to directories (folders) and leaves corresponding to files. The tree structure is described in “Iwanami's Course Book, Computer Science 8: Structure of Information and Database,” Shin Nagaoka, et al., pp. 21 to 22, Iwanami Shoten, Publishers, June 1983.

The digital broadcasting has the advantage as described above. However, since recorded data is digital data and the data can be copied without deterioration of the quality, measure for security is required in order to prevent illegal copies.

For example, SAFIA (Security Architecture For Intelligent Attachment device) is employed as the measure for security. SAFIA is a copyright protection standard based on the iVDR (Information Versatile Disk for Removable usage) which is a standard of digital content in a removable hard disk. SAFIA prescribes a rule for dividing data to be recorded into data blocks each of which has a reproducing time which is not longer than a predetermined reproducing time and for encrypting the data blocks using corresponding encryption keys before the data is stored.

In general, the video recording and reproducing apparatus is such that, when data is moved, the same pieces of data are allowed to be stored in a data source and a move destination for only a predetermined period of time. Thus, illegal copies are prevented and high security is attained.

Referring to FIGS. 3, 9, 13, and 14, a method for moving recorded data according to the related art will be described.

FIG. 3 is a diagram illustrating a data structure of recorded data having a general encryption key.

FIG. 9 is a diagram illustrating an example of a data structure of a recorded program.

FIG. 13 is a flowchart illustrating how to move recorded data according to the related art.

FIG. 14 is a diagram illustrating an image of the recorded data when the recorded data is moved according to the related art.

The recorded data is divided into a number N of data blocks Dᵢ having corresponding encryption keys Kᵢ as shown in FIG. 3.

Assuming that the recorded data is moved from an incorporated HDD to a removable HDD, the recorded data is moved in accordance with a procedure illustrated in FIG. 13.

First, 1 is assigned to avariable i in order to initialize a counter in step S100. It is determined whether the variable i is smaller than the number N in step S102. When the determination is affirmative, an encryption key Kᵢ is copied from a data source to a move destination in step S103 and a data block Dᵢ is similarly copied from the data source to the move destination in step S104. Thereafter, the encryption key Kᵢ which is stored in the data source and which has been copied in the move destination is deleted in step S105, and the data block Dᵢ which is stored in the data source and which has been copied in the move destination is similarly deleted in step S106.

Accordingly, the data blocks Dᵢ having corresponding encryption key Kᵢ is stored in both of the data source and the move destination for only a short period of time.

Then, after the variable i is incremented in step S107, the process returns to step S102 to repeatedly perform the procedure described above until the last data block Dᵢ is processed.

It is assumed that the variable i is incremented to 3 as shown in FIG. 14.

According to this method for moving recorded data in the related art, when a data moving operation is interrupted for some reasons (for example, power discontinuity), the data being recorded is divided. Specifically, the data being recorded is divided while loop processing from step S102 to step S107 shown in FIG. 12 is performed.

A user interface used to perform an operation in which a recorded file represented by the recorded data is stored in a folder which is provided individually for each user may be employed. In order to avoid duplication of data, a network configuration as shown in FIG. 9 is naturally employed.

FIG. 9 shows a data structure employed in order to store recorded programs and playlists in folders provided for individual users.

An algorithm of processing such a network configuration is not provided by general calculation processing for a tree structure. Furthermore, an algorithm of processing “all” pieces of recorded data and playlists irrespective of the users who use the pieces of recorded data is not provided.

During n-fold speed reproduction, that is, special speed reproduction, each of the pieces of recorded data are displayed by appropriately making the I pictures discrete in accordance with the number n. However, as the number n becomes larger, the time it takes for the n-fold speed reproduction becomes longer than the time it takes to process the encryption keys. This causes a problem in that an image corresponding to each of the pieces of recorded data is not displayed.

### SUMMARY OF THE INVENTION

To address this problem, in the video recording and reproducing apparatus according to the present invention, when each of the pieces of recorded data divided into data blocks having corresponding encryption keys is moved, all the data blocks are first copied to the move destination, and thereafter, the encryption keys are successively copied. After all the encryption keys are successively copied to the move destination, all the encryption keys stored in the data source are successively deleted. Thereafter, all the data blocks stored in the data source are simultaneously deleted.

Use of this method makes it possible to keep a rule that each of the encryption keys and a corresponding one of the data blocks are stored in both of the data source and the move destination for only a short period of time. Furthermore, even if the data moving operation is interrupted for some reasons, each one of the pieces of recorded data is divided only while the encryption keys are copied. Since the encryption keys are generally smaller than the data blocks, a risk that a file which is being recorded is divided is considerably small.

Furthermore, in a case where one of the pieces of recorded data is deleted or moved, one of following two operations is selected: an operation in which an entity of the one of the pieces of recorded data is deleted or moved, and an operation in which the association between a folder and the one of the pieces of recorded data to be deleted or moved is changed.

Moreover, when n-fold speed reproduction is performed, some of the data blocks representing one of the pieces of recorded data to be reproduced are made discrete for reproduction.

Accordingly, a risk that a file which is being moved is divided due to interruption of the moving operation is considerably small.

The present invention provides a simple user interface which displays programs recorded by individual users.

In addition, the present invention provides a video recording and reproducing apparatus capable of performing a reproducing operation even when a reproduction speed is increased.

### BRIEF DESCRIPTION OF DRAWINGS

FIG. 1 is a block diagram illustrating an example of a hardware configuration of a video recording and reproducing apparatus according to a first embodiment.

FIG. 2 is a block diagram illustrating a configuration of software used to control data stored in the video recording and reproducing apparatus according to the first embodiment.

FIG. 3 is a diagram illustrating a data structure of data blocks constituting recorded data and corresponding encryption keys.

FIG. 4 is a flowchart illustrating how to move recorded data according to the first embodiment.

FIG. 5 is a diagram illustrating an image of the recorded data when the recorded data is moved according to the first embodiment.

FIG. 6 is a diagram illustrating a main processing screen of recording and reproducing.

FIG. 7 is a diagram illustrating a user interface used when a recorded program is deleted.

FIGS. 8A to 8C are diagrams illustrating a user interface when a recorded program is moved.

FIG. 9 is a diagram illustrating an example of data structure of a recorded program according to a second embodiment.

FIGS. 10A and 10B are diagrams illustrating a deleting operation.

FIG. 11 is a diagram illustrating a data moving operation.

FIG. 12 is a diagram illustrating the relationship between a data structure of data blocks of general recorded data having corresponding encryption keys and I pictures.

FIG. 13 is a flowchart illustrating how to move recorded data according to the related art.

FIG. 14 is a diagram illustrating an image of the recorded data when the recorded data is moved according to the related art.

### DESCRIPTION OF THE PREFERRED EMBODIMENTS

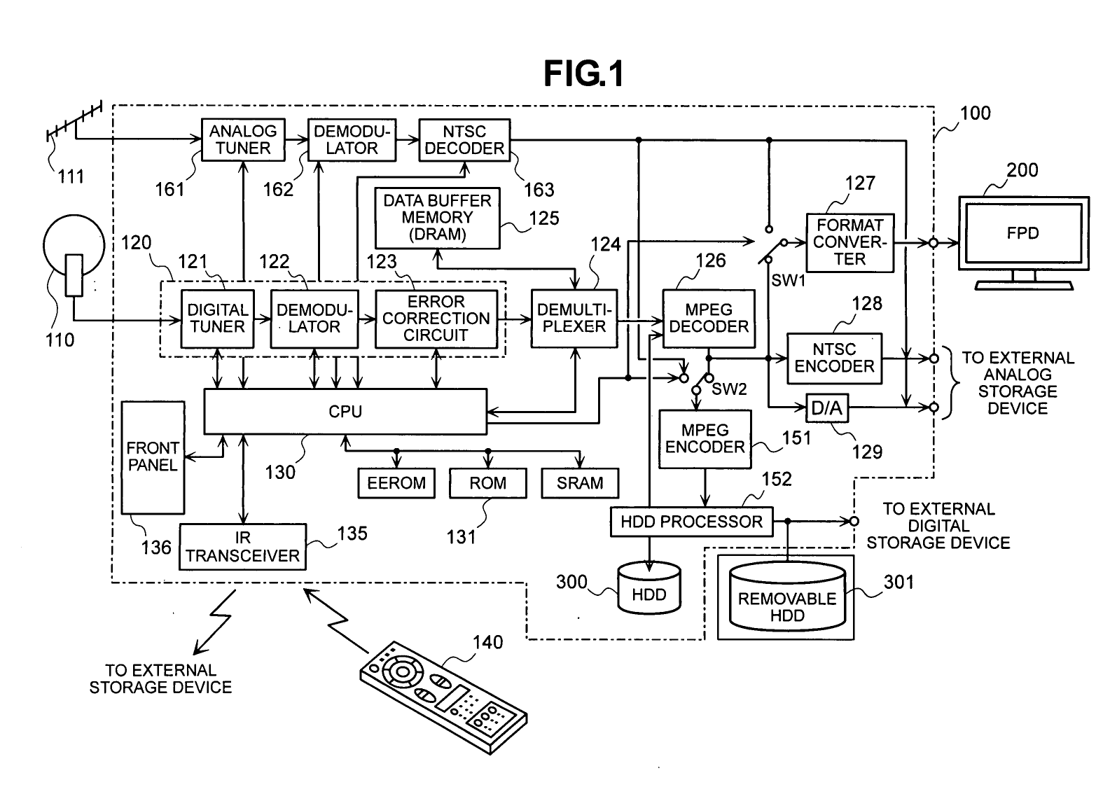

Embodiments of the present invention will be described hereinafter with reference to FIGS. 1 to 12.

### First Embodiment

A first embodiment will be described hereinafter with reference to FIGS. 1 to 12.

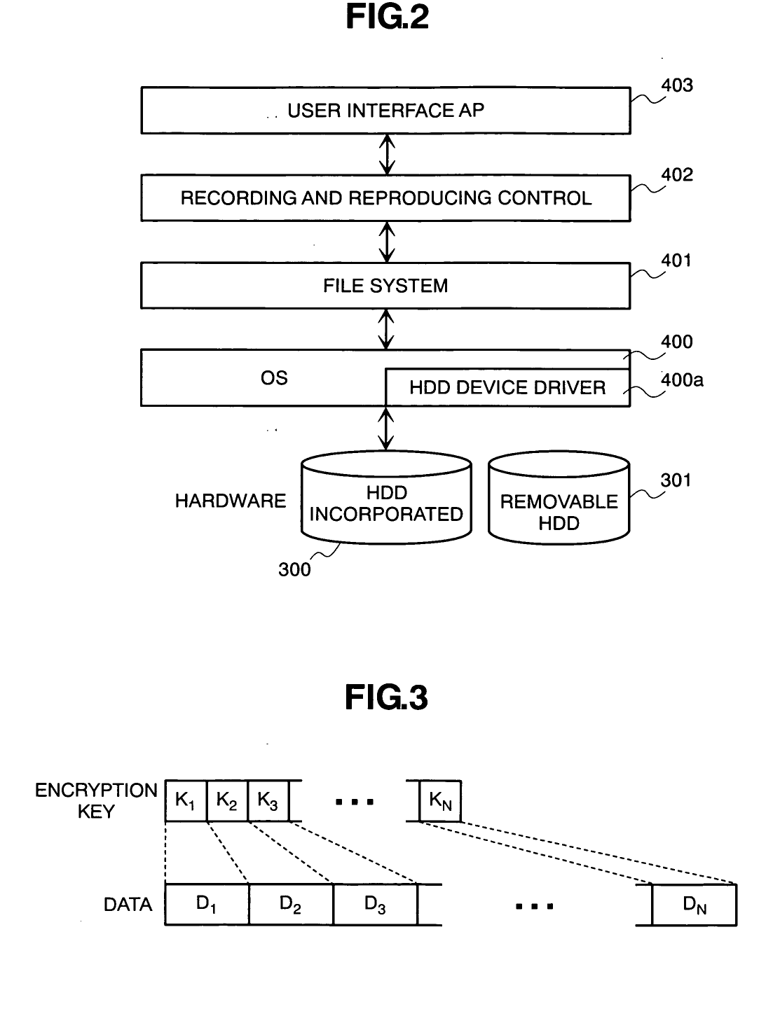

Referring to FIGS. 1 and 2, a configuration of a video recording and reproducing apparatus according to the first embodiment will be described.

FIG. 1 is a block diagram illustrating an example of a hardware configuration of the video recording and reproducing apparatus according to the first embodiment.

FIG. 2 is a block diagram illustrating a configuration of software used to control data stored in the video recording and reproducing apparatus according to the first embodiment.

A video recording and reproducing apparatus 100 is an AV (audio visual) apparatus (a broadcasting reception apparatus) which receives digital broadcasting and analog broadcasting and which displays broadcasting content (including video and audio programs, programs of data broadcasting, data of data broadcasting) on a so-called flat panel display (FPD) 200 such as a plasma display panel and a liquid crystal display panel including a speaker which reproduces and outputs sounds.

An antenna 110 is a parabolic antenna used to receive digital broadcasting. An RF signal output from the antenna 110 is supplied to a digital tuner 121 included in a digital tuner module (or a front end) 120 in the video recording and reproducing apparatus 100 and is demodulated. A signal output from the digital tuner 121 is supplied to a QPSK (quadrature phase shift keying) demodulator 122, for example, which is also included in the digital tuner module 120, and is subjected to QPSK demodulation. Furthermore, a signal output from the QPSK demodulator 122 is supplied to an error correction circuit 123, which is also included in the digital tuner module 120, where errors generated in transmission are detected and corrected. That is, the digital tuner module 120 selects a signal having a predetermined frequency and extracts a TS (transport stream).

A signal output from the error correction circuit 123 included in the digital tuner module 120 is supplied to a demultiplexer 124. The demultiplexer 124 temporarily stores the received signal in a data buffer memory (a DRAM (Dynamic Random Access Memory) or a SRAM (Static Random Access Memory)) 125, reads and decodes the signal as needed to obtain a video-and-audio signal, and supplies the video-and-audio signal to an MPEG decoder 126. That is, the demultiplexer 124 performs demultiplexing processing of extracting a desired stream from the transport stream (TS) which is generated using a multiplexer (MUX) on a transmitter side by multiplexing a plurality of streams, such as video and audio streams. In the demultiplexing processing, the demultiplexer 124 performs filtering so as to extract the desired stream among packets of various streams. Specifically, when a specific channel is selected, a PID (packet ID) of a desired video and audio stream included in service of the channel is assigned to a PMT (photomultiplier) corresponding to the channel. Therefore, in a reception side, the desired video and audio stream is extracted by obtaining a packet having the PID through filtering. A program in association with the video and audio stream is thus displayed.

Thereafter, the video and audio stream extracted using the demultiplexer 124 is supplied to the MPEG decoder 126. The MPEG decoder 126 controls the data buffer memory 125 such as a DRAM included in the video recording and reproducing apparatus 100 to store a supplied digital signal representing the video and audio stream as needed, and performs decoding processing on the video-and-audio signal which has been compressed according to the MPEG standard (the MPEG-2 standard, in particular).

The video recording and reproducing apparatus 100 has an antenna 111 used to receive analog broadcasting and further has an analog tuner module including an analog tuner 161, an analog demodulator 162, and an NTSC (National Television Standards Committee) decoder 163. A video-and-audio signal of a program broadcasted by an analog method is output from the analog tuner module.

One of the video-and-audio signal received using the digital tuner module 120 and the video-and-audio signal converted into a predetermined form using the analog tuner module in the video recording and reproducing apparatus 100 as described above is selected using a switch SW1. The selected signal is converted into a predetermined format using a format converter 127 and is output to the flat panel display (FPD) 200 such as a plasma display or a liquid crystal display for display. Furthermore, these video-and-audio signals are output to an external analog apparatus such as a CRT (Cathode Ray Tube) display or a VCR (Video Cassette Recorder) as shown in FIG. 1. Thus, data corresponding to the video-and-audio signal is recorded using the external apparatus. Note that the video-and-audio signal converted into the predetermined format using the MPEG decoder 126 is further supplied to an NTSC (National Television Standards Committee) encoder 128 to be converted into a signal of a so-called NTSC format and output from the NTSC encoder 128. The video-and-audio signal output from the MPEG decoder 126 is also supplied to a D/A converter 129 to be converted into an analog audio signal and output from the D/A converter 129.

As shown in FIG. 1, the video recording and reproducing apparatus 100 further includes a CPU (Central Processing Unit) 130 which performs various processes in accordance with programs stored in a ROM (Read-Only memory) 131. For example, the CPU 130 controls the digital tuner module 120 including the digital tuner 121, the QPSK demodulator 122, and the error correction circuit 123, and the analog tuner module. Furthermore, the CPU 130 includes an IR (Infrared radiation) transceiver 135 which radiates and receives an infrared ray. The CPU 130 outputs a predetermined control signal to another AV apparatus through the IR transceiver 135 and receives a control signal transmitted from another AV apparatus through the IR transceiver 135.

Various instructions may be directly input to the CPU 130 by operating various operation button switches on a front panel 136 disposed on a front surface of the video recording and reproducing apparatus 100. Moreover, a so-called remote controller 140 is provided separately from the video recording and reproducing apparatus 100. The various instructions may be input as input signals by operating various buttons arranged on the remote controller 140. Each of the input signals is transmitted to the IR transceiver 135 by an infrared ray output from an IR transmission unit disposed in an end portion of the remote controller 140. The input signal is also supplied to the CPU 130, and accordingly, a predetermined instruction may be issued to the CPU 130 by operating the remote controller 140.

The video recording and reproducing apparatus 100 further includes a hard disk drive (HDD) 300 used to record program content (video-and-audio information). Note that the video-and-audio signal decoded using the MPEG decoder 126 is compressed to obtain a digital compression signal using an MPEG encoder 151, and the compression signal is supplied to a HDD processor 152. The HDD processor 152 performs predetermined processing of recording the compression signal as recorded data to the HDD 300. As indicated by an arrow in FIG. 1, the video-and-audio signal decoded using the MPEG decoder 126 is directly input to the HDD processor 152. On the other hand, when the data recorded in the HDD 300 is to be reproduced, the compression signal is read from the HDD 300 and is returned through the HDD processor 152 to the MPEG decoder 126. That is, the recorded data is decoded to obtain a video-and-audio signal, and the video-and-audio signal is converted into a predetermined format using the format converter 127, is further supplied to the flat panel display (FPD) 200, and is reproduced. Alternatively, the video-and-audio signal decoded using the MPEG decoder 126 is supplied to an external apparatus such as a VCR or a DVD (Digital Versatile Disk) recorder. Note that, in FIG. 1, a switch SW2 is used to select one of the video-and-audio signal supplied from the analog tuner module and the video-and-audio signal received using the digital tuner module 120 and converted using the MPEG decoder 126.

The video recording and reproducing apparatus 100 further includes a so-called digital information recording device such as a removable HDD 301. The compression signal read from the HDD 300 may be recorded in the removable HDD 301 through the HDD processor 152. The HDD processor 152 has a terminal for outputting the compression signal read from the HDD 300 to an external digital recording apparatus.

Furthermore, a user issues instructions of performing a moving operation and a deleting operation for a recorded file represented by the data recorded in the HDD 300 using the operation button switch or the remote controller 140 on the front panel 136.

Referring to FIG. 2 in which a configuration of software used to control the recorded data representing the recorded file is illustrated, a user interface AP 403, a recording and reproducing control 402, a file system 401, and an operating system (OS) 400 are designed in this order from an upper layer. The operating system 400 includes an HDD device driver 400a.

The user interface AP 403 is a program group used to control screen display and to accept instructions issued by the user. The recording and reproducing control 402 is a program group used to issue an instruction for moving or deleting files and to reproduce video-and-audio data. The file system 401 is a program group used to implement files in a data configuration and to operate the files. The operating system 400 is a basic program working as an interface between software and hardware. The HDD device driver 400a is control software used to access the HDD 300.

These program groups are loaded from a system area of the HDD 300 or the ROM 131 to the data buffer memory 125 and are executed by the CPU 130.

Referring to FIGS. 3 and 5, the moving operation of a recorded file according to the first embodiment will be described.

FIG. 3 is a diagram illustrating a data structure of recorded data divided into data blocks having corresponding encryption keys.

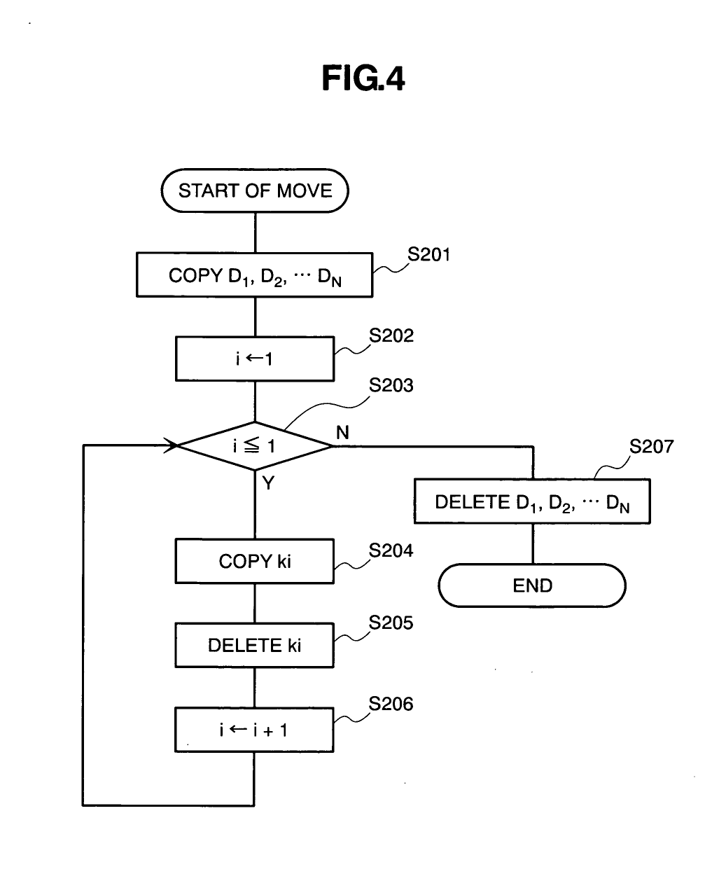

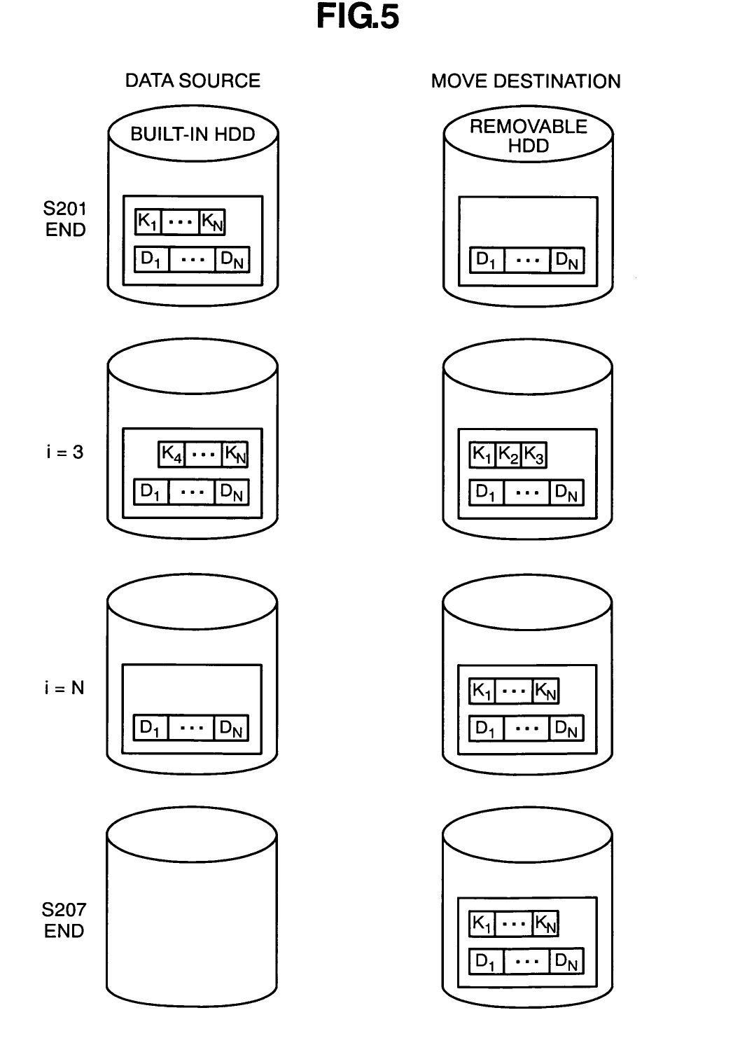

FIG. 4 is a flowchart illustrating a procedure of a method for moving the recorded data according to the first embodiment.

FIG. 5 is a diagram illustrating an image of the recorded data when the recorded data is moved in accordance with the method for moving recorded data according to the first embodiment.

The recorded data is divided into a number N of blocks Dᵢ and the blocks Dᵢ have corresponding encryption keys Kᵢ.

It is assumed that the recorded data is moved from an incorporated HDD to a removable HDD separately provided. In this case, the moving operation is performed in accordance with a procedure shown in FIG. 4.

First, data blocks D₁ to D_{N} are copied from a data source to a move destination in step S201.

Then, 1 is assigned to a variable i to initialize a counter in step S202. It is determined whether the variable i is smaller than the number N in step S203. When the determination is affirmative in step S203, the process proceeds to step S204 where an encryption key Kᵢ corresponding to the data block Dᵢ is copied to the move destination. Thereafter, the encryption key Kᵢ stored in the data source is deleted in step S205.

Accordingly, each of the encryption keys Kᵢ is stored in both of the data source and the move destination for only a short period of time.

After the variable i is incremented in step S206, the process returns to step S203. The steps S203 to S206 are repeated until the last encryption key Kᵢ is processed.

When the determination is negative in step S203, the data blocks D₁ to D_{N} stored in the data source are deleted in step S207.

FIG. 5 shows states of recorded data while the recorded data is moved in accordance with the moving operation described above. Specifically, FIG. 5 shows four states: a state of the recorded data when the process performed in step S201 is completed, a state of the recorded data when 3 is assigned to the variable i, a state of the recorded data when N is assigned to the variable i, and a state of the recorded data when the process performed in step S207 is completed.

According to the first embodiment described above, if the moving operation is interrupted during loop processing from step S203 to step S206, the recorded file is divided. However, since data of each of the encryption keys Kᵢ is considerably small when compared with each of the data blocks Dᵢ included in the recorded data, it is possible to decrease a risk that the file being recorded is divided when compared with the related art.

### Second Embodiment

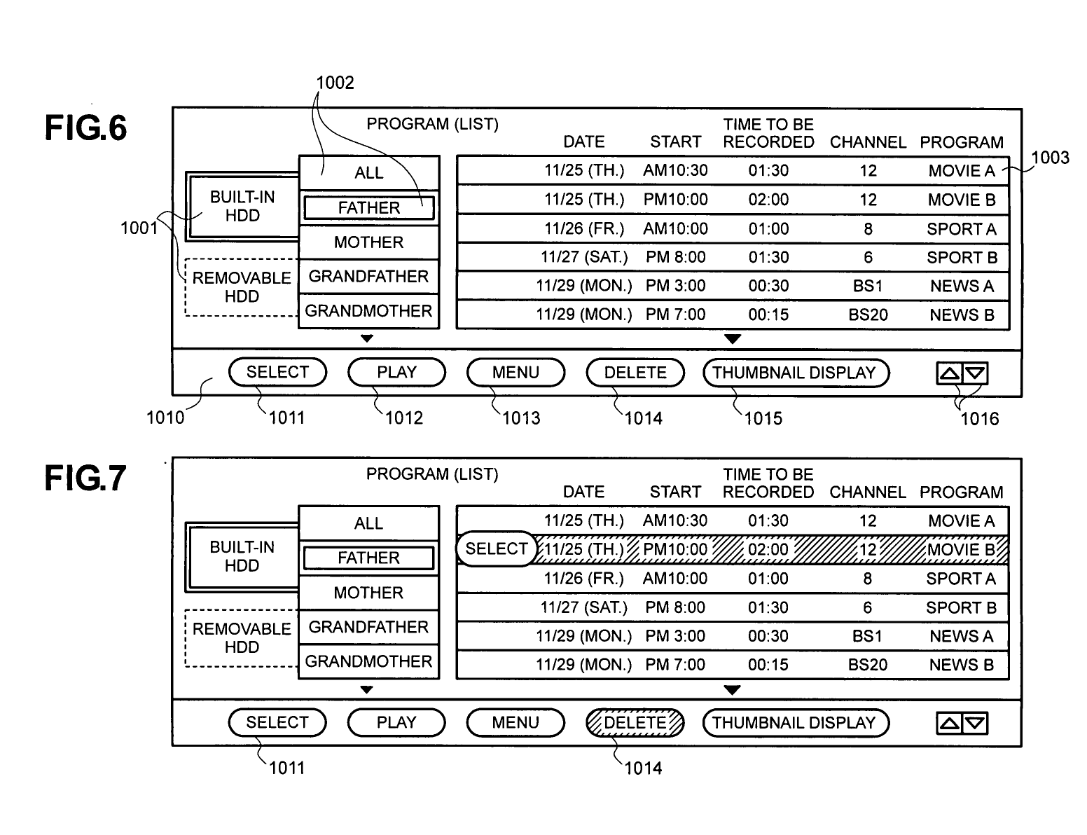

A second embodiment will be described hereinafter with reference to FIGS. 6 to 11.

In this second embodiment, moving and deleting operations performed using the video recording and reproducing apparatus according to the invention will be described.

First, a main screen of recording and reproducing processing will be described with reference to FIG. 6.

FIG. 6 shows a diagram illustrating the main screen of recording and reproducing processing.

In the main screen of recording and reproducing processing, recorded programs are displayed so that users perform operation instructions.

HDD switching buttons 1001 are used to determine whether an incorporated HDD or a removable HDD is used for recording. In FIG. 6, for example, an incorporated HDD is selected.

A folder menu 1002 shows folders and recorded programs stored in the corresponding folders. Users who record programs may create the folders as needed. Here, one recorded program may belong to a plurality of folders. For example, a program named “movie A” belongs to a folder “mother” and may also belong to a folder “father.” Note that a folder “All” specially provided is used to display the recorded programs in all the folders.

A recorded program menu 1003 shows pieces of information corresponding to the recorded programs. In FIG. 6, although dates of recording, start times, lengths of recording times, channels, and program names, for example, are displayed, other pieces of information may be displayed. Although the pieces of information are displayed in a list in FIG. 6, thumbnails (reduced images displayed as a list) of the pieces of information may be displayed.

A command area 1010 includes buttons performing various operations. To perform a desired one of the various functions associated with the buttons, a corresponding one of the various operation button switches arranged on the front panel 136 is selected or a cursor is operated using the remote controller 140 to select one of the buttons. The desired one of the various functions is thus performed after the selection of the desired button (by pressing an enter key) or is performed by pressing a key corresponding to the desired button to be executed.

Referring to FIGS. 6 and 7, a user interface used in moving and deleting operations for one of the recorded programs will now be described.

FIG. 6 is a diagram illustrating a user interface used in the deleting operation for one of the recorded programs.

FIG. 7 is a diagram illustrating a user interface used in the moving operation for one of the recorded programs.

In the deleting operation, the cursor is moved to select one of the recorded programs to be deleted in a list of the recorded programs in the recorded program menu 1003, and a “select” button 1011 is pressed to confirm the selection of the one of the recorded program to be deleted, and then, a “delete” button 1014 is pressed to delete it. In an example shown in FIG. 6, a user tries to delete a “movie B” program from the folder “father.”

Although not shown, a dialogue for confirming the deletion is normally shown before the user deletes the one of the recorded programs.

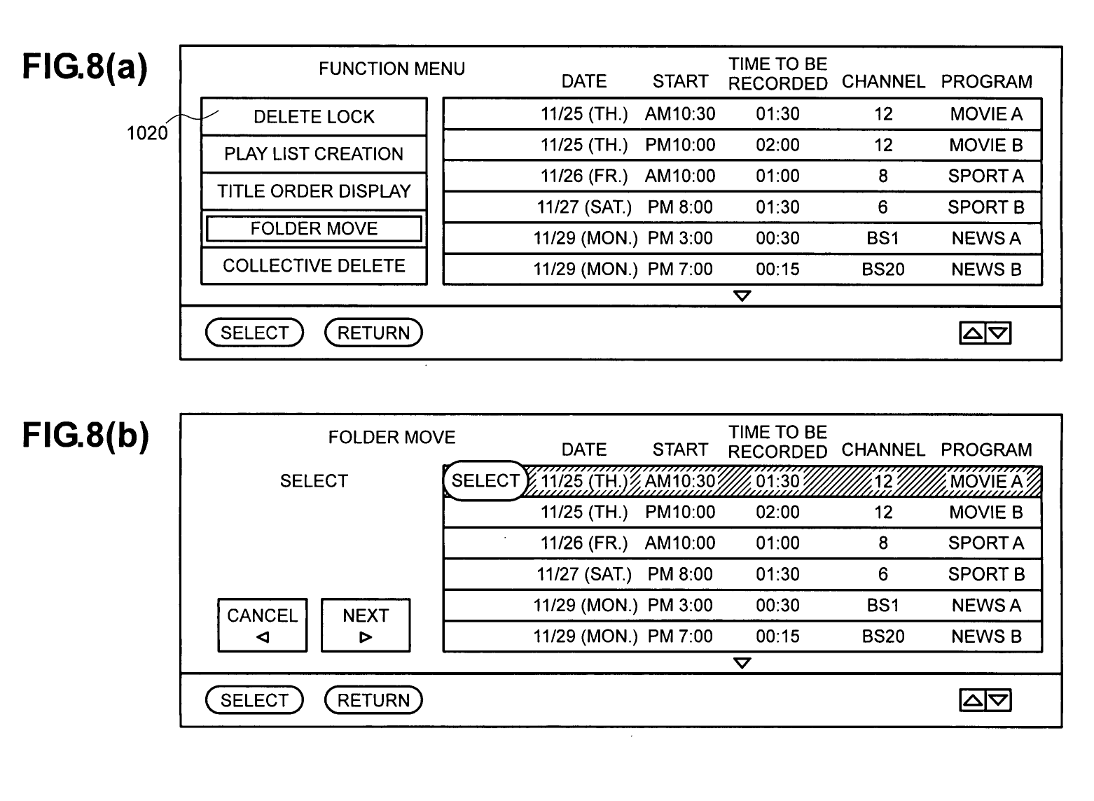

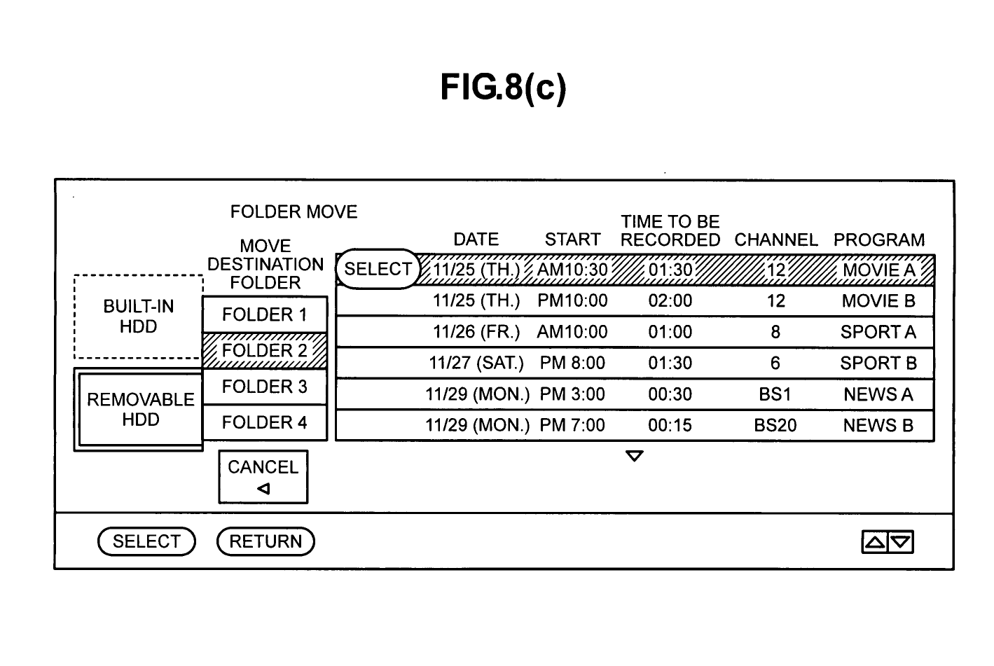

In the moving operation, a “menu” button 1013 is pressed in order to display a menu list 1020 shown in FIG. 8A, and a “folder move” button is selected.

One of the recorded programs to be moved is selected as shown in FIG. 8B. Then, the screen is changed to the next screen where one of folders in the move destination is selected as shown in FIG. 8C, and the moving operation is executed (by pressing the enter key).

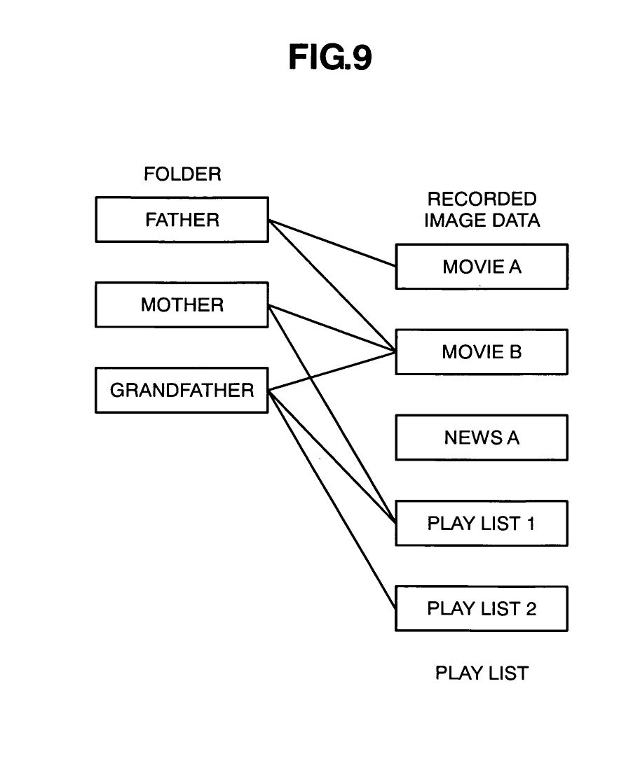

Referring to FIGS. 9 to 11, the moving and deleting operations for one of the recorded programs will now be described.

FIG. 9 is a diagram illustrating an example of data structure of one of the recorded programs.

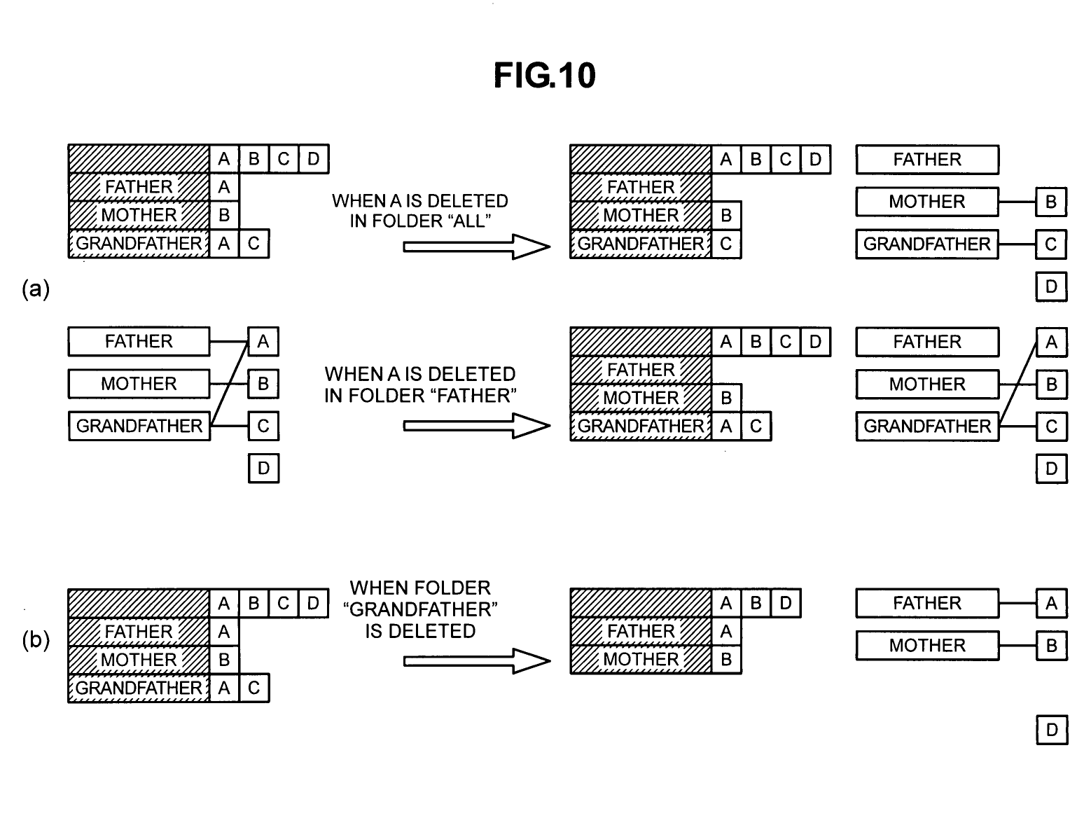

FIG. 10 is a diagram illustrating the deleting operation.

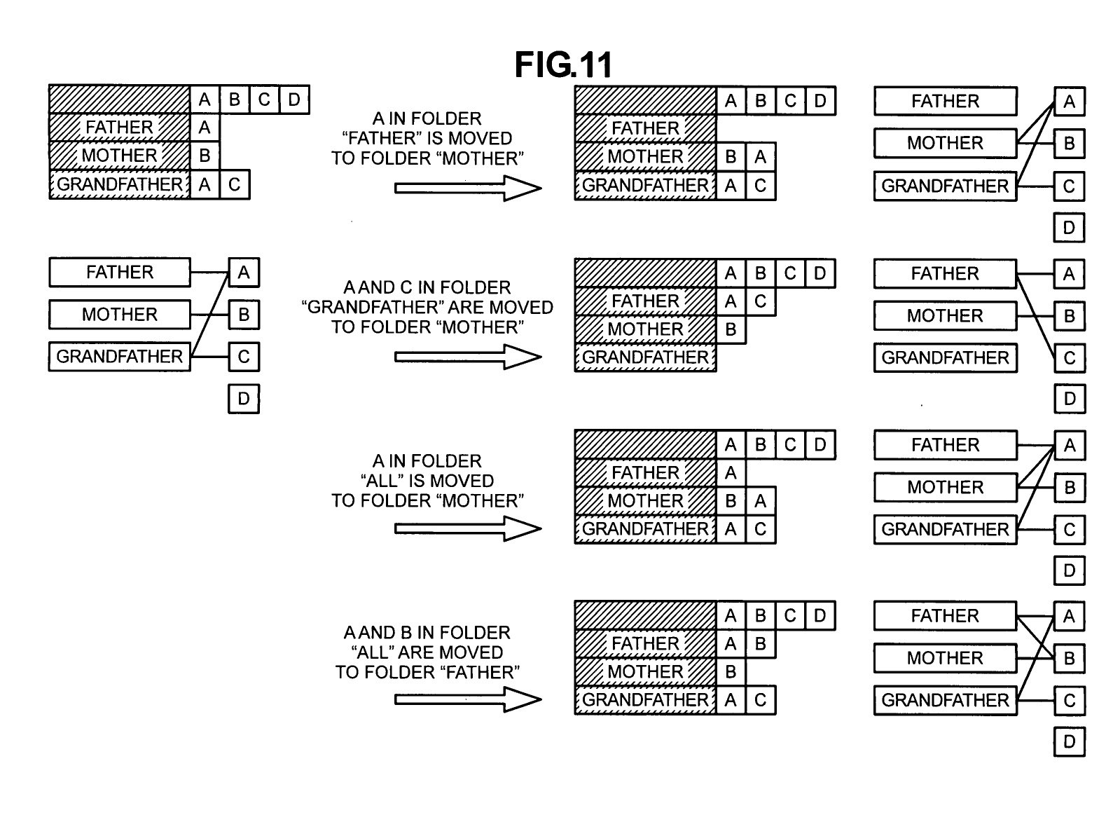

FIG. 11 is a diagram illustrating the moving operation.

As shown in FIG. 9, in the data structure which is employed in order to realize the recording processing of the second embodiment, the folders such as the folder “father” and the folder “mother” are networked with pieces of recorded program data and playlists. Each of the pieces of recorded program data includes management information relating to image data and recording. The playlists are represented by pieces of schedule management data used at a time of reproduction. The pieces of recorded program data and the pieces of schedule management data representing the playlists are referred to as pieces of entity data hereinafter.

Referring to FIG. 10, the deleting operation of this embodiment performed on the basis of the data structure shown in FIG. 9 will be described.

Note that, although the folder “All” is not shown in the data structure of FIG. 9, the folder “All” is a pseudo folder which is used to display all the pieces of entity data for the user so that any of the pieces of entity data is processed.

The deleting operation is basically performed as follows.

(1) When a specific one of the pieces of entity data in the folder “All” is deleted, the associations between the specific one of the pieces of entity data and the other folders are also deleted.

(2) When a specific one of the pieces of entity data representing a recorded program to be deleted is not associated with any of the folders other than the folder “All,” the specific one of the pieces of entity data is deleted.

(3) When a specific one of the pieces of entity data representing a recorded program to be deleted is associated with at least one of the folders other than the folder “All,” the associations between the specific one of the pieces of entity data and the corresponding folders are deleted.

As shown in FIG. 10A, for example, when the folder “All” is selected to delete a recording program A, entity data of the recording program A is deleted.

For example, when the folder “father” is selected and the recording program A is deleted, the association between the folder “father” and the entity data of the recording program A is deleted but the entity data of the recording program A is not deleted, since the recording program A is also associated with a folder “grandfather.” Although not shown, when a folder “mother” is selected and a recording program B is deleted, entity data of the recording program B is deleted, since the recording program B is associated with only the folder “mother,” expect for the folder “All,” that is, the recording program B is not associated with the folders other than the folder “mother” and the folder “All.”

Furthermore, as shown in FIG. 10B, when the folder “grandfather” is deleted, the entity data of the recording program A is not deleted but entity data of a recording program C is deleted, since the recording program A is also associated with the folder “father” but the recording program C is not associated with other folders except for the folder “All.”

The moving operation of this embodiment which is performed on the basis of the data structure shown in FIG. 9 will now be described with reference to FIG. 11.

The moving operation is basically performed by changing the associations between the folders and the pieces of entity data.

When the folder “father” is selected and the recording program A included in the folder “father” is moved to the folder “mother,” the association between the folder “father” and the entity data representing the recording program A is changed to the association between the folder “mother” and the entity data representing the recording program A.

When the folder “grandfather” is selected and the recording programs A and C included in the folder “grandfather” are moved to the folder “father,” the association between the folder “father” and the entity data representing the recording program A is not changed and the association between the folder “grandfather” and the entity data representing the recording program C is changed to the association between the folder “father” and the entity data representing the recording program C.

When the folder “All” is selected and the recording program A is moved to the folder “mother,” the association between the folder “mother” and the entity data representing the recording program A is added.

When the folder “All” is selected and the recording programs A and B are moved to the folder “father,” the association between the folder “father” and the entity data representing the recording program A is not changed and the association between the folder “father” and the entity data representing the recording program B is added.

### Third Embodiment

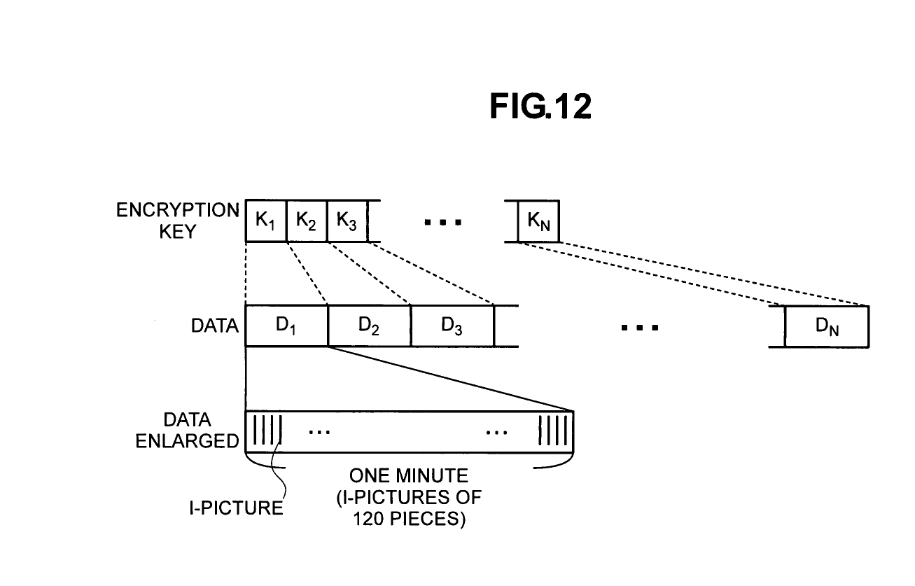

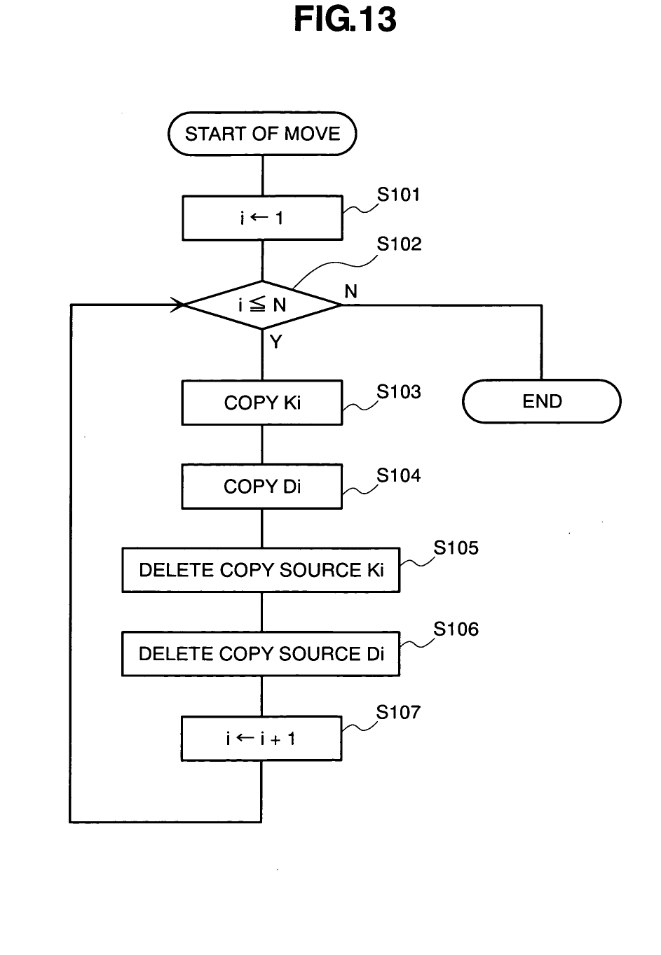

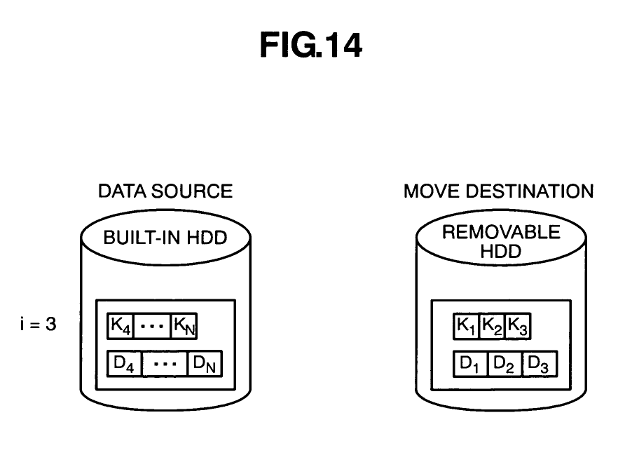

A third embodiment will be described hereinafter with reference to FIG. 12.

FIG. 12 is a diagram illustrating the relationship between a data structure of general recorded data having corresponding encryption keys and I pictures.

In this embodiment, an n-fold speed reproducing operation (n is a natural number) of the video recording and reproducing apparatus according to the present invention is described.

It is assumed that, as shown in FIG. 12, MPEG data is divided into a plurality of data blocks having corresponding encryption keys, and it takes one minute (sixty seconds) to reproduce each of the plurality of data blocks. Each of the plurality of data blocks includes 120 I pictures.

Examples of statuses of the video recording and reproducing apparatus of the related art when reproductions are performed at a speed of between 1 to 120-times the normal speed are shown in a table 1.

TABLE 1
Relation between fast reproduction and normal reproduction

| Fast | No. of displayed | Time it takes | | Displayed I |
|---|---|---|---|---|
| reproduction | pictures/sec. | to read key | | pictures |
| 1 | 2 | 60 | sec. | All displayed |
| 2 | 4 | 30 | sec. | All displayed |
| 10 | 20 | 6 | sec. | All displayed |
| 30 | 20 | 2 | sec. | 1/3 displayed |
| 60 | 20 | 1 | sec. | 1/6 displayed |
| 120 | 20 | 0.5 | sec. | 1/12 displayed |

When a single-speed reproduction is performed, two I pictures are displayed per second in a screen and all the I pictures included in the recorded data are displayed. The encryption keys are successively read every 60 seconds.

When a double-speed reproduction is performed, four I pictures are displayed per second in a screen and all the I pictures included in the recorded data are displayed. The encryption keys are successively read every 30 seconds.

When a 10-fold speed reproduction is performed, 20 I pictures are displayed per second in a screen and all the I pictures included in the recorded data are displayed. The encryption keys are successively read every 6 seconds.

When the reproducing operation at a speed of more than 10-fold speed is performed, some of the I pictures included in each of the data blocks are eliminated and the rest of the I pictures are displayed.

Furthermore, when the reproducing operation at a speed of more than 10-fold speed is performed, the number of I pictures displayed per second is fixed to 20, that is, some of the I pictures are made discrete so that the number of I pictures displayed per second is reduced.

When a 30-fold speed reproduction is performed, 20 I pictures are displayed per second in a screen and one third of the I pictures included in the recorded data are displayed. The encryption keys are successively read every two seconds.

When a 60-fold speed reproduction is performed, 20 I pictures are displayed per second in a screen and one sixth of the I pictures included in the recorded data are displayed. The encryption keys are successively read every one second.

When a 120-fold speed reproduction is performed, 20 I pictures are displayed per second in a screen and one twelfth of the I pictures included in the recorded data are displayed. The encryption keys are successively read every 0.5 seconds.

In the speed reproduction operation of the related art, when the high-speed reproducing operation is performed at a speed of as much as 120 times the normal speed, time intervals between a time when one of the encryption keys is read and a time when the next one of the encryption keys is read are considerably short. Therefore, there arises a problem in that a system capability is not enough to properly reproduce the recorded data.

Accordingly, in this embodiment, for example, some of the encryption keys and the data blocks to be reproduced are made discrete, when the recorded data is displayed. That is, the reproducing operation is performed in an order of (K₁, D₁), (K₂, D₂), (K₃, D₃), (K₄, D₄), (K₅, D₅) to (K_{N}, D_{N}) in the related art, whereas the reproducing operation is performed in an order of (K₁, D₁), (K₃, D₃), (K₅, D₅), (K₇, D₇) and so on by making discrete even-numbered encryption keys and even-numbered data blocks in this embodiment. In this case, the one sixth of the I pictures included in the data blocks are displayed.

Accordingly, the time intervals between a time when one of the encryption keys is read and a time when the next one of the encryption keys is read are twice the time intervals in the related art. That is, for example, when the 120-fold speed reproduction is performed, the encryption keys are successively read every one second. Although the user recognizes that some pictures are skipped, since a time used to reproduce each of the data blocks is twice the time of the reproducing operation of the related art, a user-friendly display is achieved.

In addition, a reproducing operation in which the first I picture and the last I picture in each of the data blocks are invariably displayed may be employed.

What is claimed is:

1. A video recording and reproducing apparatus having a recording medium to which pieces of data are to be recorded, the video recording and reproducing apparatus,
wherein:
said video recording and reproducing apparatus records the pieces of data by dividing each of the pieces of data into a plurality of data blocks encrypted with corresponding encryption keys;
said video recording and reproducing apparatus copies all the data blocks from a data source to a move destination in the recording medium;
said video recording and reproducing apparatus successively copies the encryption keys from the data source to the move destination in the recording medium and successively delete the encryption keys; and
said video recording and reproducing apparatus deletes all the data blocks stored in the data source in the recording medium.

2. A method for moving pieces of recorded data stored in a video recording and reproducing apparatus having a recording medium to which pieces of data are to be recorded, when each of the pieces of recorded data which is divided into a plurality of data blocks encrypted corresponding encryption keys is moved from a data source to a move destination in the recording medium, the method comprising the steps of:
copying all the data blocks from the data source to the move destination in the recording medium;
successively copying the encryption keys from the data source to the move destination in the recording medium and successively deleting the encryption keys in the data source; and
deleting all the data blocks stored in the data source in the recording medium.

3. A method for accessing pieces of recorded data stored in a video recording and reproducing apparatus having a recording medium to which pieces of data are to be recorded,
wherein the pieces of recorded data are associated with a plurality of folders, and
in a case where a specific folder among the plurality of folders is selected and a specific one of pieces of recorded data included in the specific folder is to be deleted, when the specific one of the pieces of recorded data to be deleted is not associated with any of the other folders, the specific one of the pieces of recorded data is deleted, and when the specific one of the pieces of recorded data to be deleted is associated with at least one of the other folders, only an association between the selected folder and the specific one of the pieces of recorded data is deleted.

4. A method for accessing pieces of recorded data stored in a video recording and reproducing apparatus having a recording medium to which pieces of data are to be recorded,
wherein the pieces of recorded data are associated with a plurality of folders, and
when a first folder as a data source and a second folder as a move destination are selected among a plurality of folders and one of the pieces of recorded data is to be moved from the data source to the move direction, an association between the one of the pieces of recorded data to be moved and the first folder is changed to an association between the one of the pieces of recorded data to be moved and the second folder.

5. A video recording and reproducing apparatus having a recording medium to which pieces of recorded data are to be recorded,
wherein said video recording and reproducing apparatus records the pieces of recorded data to the recording medium by dividing each of the pieces of recorded data into a plurality of data blocks encrypted with corresponding encryption keys, and
wherein said video recording and reproducing apparatus reproduces each of the pieces of recorded data by making some of the plurality of data blocks discrete in accordance with a speed of the reproduction.

6. A method for high-speed reproduction of pieces of recorded data of a video recording and reproducing apparatus having a recording medium to which pieces of data are to be recorded,
wherein when each of the pieces of recorded data which is divided into a plurality of data blocks encrypted with corresponding encryption keys and which is recorded in the recording medium is performed speed reproduction, each of the pieces of recorded data is reproduced by making some of the plurality of data blocks discrete in accordance with a speed of the reproduction.
